(19) United States
(12) Patent Application Publication
(10) Pub. No.: US 2011/0029319 A1
(43) Pub. Date: Feb. 3, 2011

(54) IMPRESSION FORECASTING AND RESERVATION ANALYSIS

(75) Inventors: Bryan C. Mills, Pittsburgh, PA (US); Paul R. Mecklenburg, Pittsburgh, PA (US); Ruggero Morselli, Pittsburgh, PA (US); Robert D. Sedgewick, Pittsburgh, PA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/603,209

(22) Filed: Oct. 21, 2009

Related U.S. Application Data
(60) Provisional application No. 61/229,477, filed on Jul. 29, 2009.

(51) Int. Cl. G06Q 10/00; G06Q 50/00

(52) U.S. Cl. 705/2

(57) ABSTRACT

Methods, systems, and apparatus, including computer programs encoded on a computer storage medium, for processing sharded reservation queries for corresponding publisher data shards. Each publisher data shard stores a proper subset of impression records corresponding to a publisher site and a plurality of user identifiers. Each impression record includes user identifier data corresponding to a user identifier and time data specifying a time that an impression was delivered for the publisher site for the corresponding user identifier, and all impression records corresponding to the user identifiers are stored in the publisher data shard.

### CROSS-REFERENCED TO RELATED APPLICATIONS

This application claims the benefit under 35 U.S.C. §119(e) of U.S. Patent Application No. 61/229,477, titled “IMPRESSION FORECASTING AND RESERVATION ANALYSIS,” filed Jul. 29, 2009, which is incorporated herein by reference.

### BACKGROUND

This specification relates to online advertising.

The Internet provides access to a wide variety of resources, such as video and/or audio files, as well as web pages for particular subjects or particular news articles. Access to these resources has provided opportunities for advertisements to be provided with the resources. For example, web pages can include advertisement slots in which advertisements can be presented. The advertisements slots can be defined in the web page or defined for presentation with a web page.

There are many ways advertisements can be placed on publisher web sites. One way is by use of reservations. A reservation is an impression reserved by a publisher for an advertiser in advance of the impression occurring. Publishers and advertisers agree, for example, on a date range during which advertisements will be shown, the number of impressions that will be delivered, and optionally other restrictions, examples of which include geo targeting, frequency caps, and audience demographics.

When negotiating reservations, advertisers and publishers rely on past impression for the publishers' web sites to predict future impressions for the web sites. Additionally, advertisers and publishers must be able to allocate impressions to multiple reservations efficiently. Accordingly, such negotiations require managing of existing allocations of traffic (reservations), predicting future impressions for the sites and attributes of the impressions (e.g., gender, location, etc.), and answering questions regarding the feasibility of new reservations.

### SUMMARY

In general, one aspect of the subject matter described in this specification can be embodied in methods that include the actions of receiving at a data processing apparatus a reservation query specifying a plurality of reservations and including data specifying, for each of the reservations a date range for the reservation during which content is to be displayed with a web resource, each display of the content constituting an impression; and a number of requested impressions to deliver during the date range for the reservation; receiving at the data processing apparatus forecasted impressions, each forecasted impression specifying an impression time that the forecasted impression occurs, wherein the forecasted impressions are received in random order with respect to the impression times of the forecasted impressions, and for each forecasted impression: determining at the data processing apparatus a set of matching reservations from the reservation query and the forecasted impression, the set of matching reservations being reservations that the forecasted impression satisfies; comparing at the data processing apparatus a satisfaction value for each reservation in the set of matching reservations to other satisfaction values of other reservations in the set of matching reservations, each satisfaction value for a reservation based on a number of forecasted impressions currently assigned to the reservation and the number of requested impressions for the reservation; and assigning the forecasted impression to one of the reservations in the set of matching reservations based on the comparison of the satisfaction values. Other embodiments of this aspect include corresponding systems, apparatus, and computer programs, configured to perform the actions of the methods, encoded on computer storage devices.

Another aspect of the subject matter described in this specification can be embodied in methods that include the actions of receiving at a mixer server a reservation query for one or more reservations, the reservation query including, for each of the one or more reservations, data specifying a date range for the reservation during which content is to be displayed with a web resource, a number of requested impressions to deliver during for the reservation during the date range, and a publisher identifier identifying a publisher site hosting the web resource; translating at the mixer server the reservation query into a plurality of sharded reservation queries and providing each sharded reservation query from the mixer server to a corresponding query server, wherein each query server processes an associated publisher data shard; each publisher data shard stores a proper subset of impression records corresponding to the publisher site and a plurality of user identifiers, each impression record including user identifier data corresponding to a user identifier and time data specifying a time that an impression was delivered for the publisher site for the corresponding user identifier, and all impression records corresponding to the user identifiers are stored in the publisher data shard; at each query server: determining forecasted impressions for the publisher site from the impression records stored in the publisher data shard, each forecasted impression specifying an impression time that the forecasted impression occurs; assigning forecasted impressions that match the sharded reservation query to the one or more reservations; and providing reservation results data specifying the number of forecasted impressions assigned to each of the one or more reservations to the mixer server; and aggregating at the mixer server the reservation results data received from the query servers and providing the aggregated reservation results data as a response to the reservation query. Other embodiments of this aspect include corresponding systems, apparatus, and computer programs, configured to perform the actions of the methods, encoded on computer storage devices.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an environment 50 in which an inventory management system can be utilized

FIG. 2 is a block diagram illustrating a process flow for generating sharded publisher data.

FIG. 3 is a block diagram of a mixer and query server.

FIG. 4 is a block diagram of a file storage structure for sharded publisher data at a query server.

FIGS. 5A-5E are block diagrams illustrating assignment of impressions to reservations according to a satisfaction values.

FIG. 6 is a flow diagram of an example process for assigning impression reservations according to satisfaction values.

FIG. 7 is a flow diagram of an example process for forecasting impressions.

FIG. 8 is a flow diagram of an example process for processing a reservation query.

FIG. 9 is a flow diagram of an example process for generating publisher data shards.

FIG. 10 is a flow diagram of an example process for generating publisher data shards by determining a nearest hash index change.

FIG. 11 is a flow diagram of an example process for generating publisher data shards by a modulus of a hashed identifier.

FIG. 12 is a block diagram of a programmable processing system.

Like reference numbers and designations in the various drawings indicate like elements.

### DETAILED DESCRIPTION

In general, the subject matter of this specification relates to simulating the allocation of advertisements to forecasted impressions. A forecasted impression is a forecast of an impression during a future time period. In effect, an inventory management system described in this specification can generatively forecast a stream of future impressions (inventory) for a publisher by simulating advertisement serving allocations on a set of reservations. In addition, the system can perform a simulation to evaluate whether a particular set of reservations is feasible for a set of publishers. As reservation is feasible if the reservation can be fully satisfied (e.g., 100% of requested impressions assigned) or satisfied to an acceptable threshold level (e.g., 90% of requested impressions assigned).

In some implementations, the inventory management system can simulate advertisement serving tasks such as frequency capping and road blocking. Frequency capping is a technique used to restrict (i.e., cap) the amount of times (i.e., frequency) a specific visitor or class of visitors to a website is shown a particular advertisement. The restriction is typically applied to all websites that serve ads from the same advertising network. Road blocking is a technique used to schedule two or more advertisements for simultaneous showing on a web page of the web site.

### §1.0 Example Operating Environment

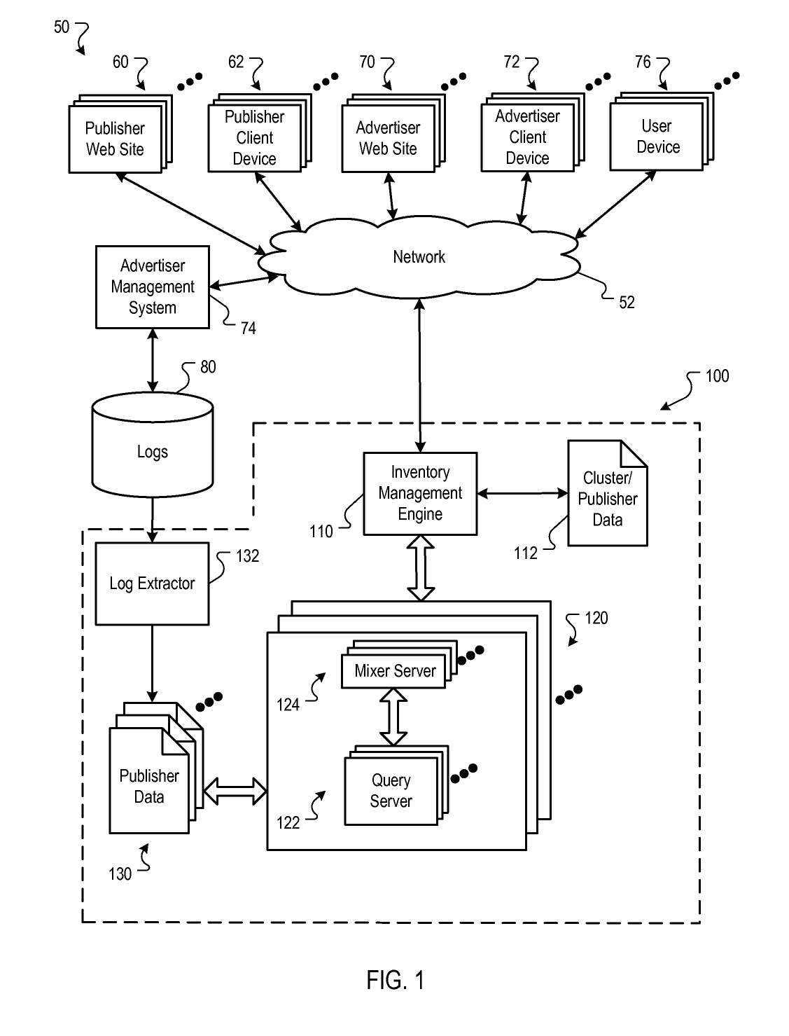

FIG. 1 is a block diagram of an environment 50 in which an inventory management system 100 can be utilized. In general, the inventory management system 100 facilitates the negotiation and, optionally, the sale of future advertisements as reservations. The inventory management system 100 receives reservation queries from publishers or advertisers. A reservation query is a query that specifies one or more reservations. Each reservation includes a date range for the reservation during which content is to be displayed with a web resource, and a number of requested impressions to deliver during the date range for the reservation.

The environment 50 includes a computer network 52, such as a local area network (LAN), wide area network (WAN), the Internet, or a combination thereof, connecting publisher web sites 60, publisher client devices 62, advertiser web sites 70, advertiser client devices 72, an advertiser management system 74, user devices 76, and the inventory management system 100.

Each web site 60 is one or more web page resources associated with a domain name, and each web site is hosted by one or more servers. An example web site is a collection of web pages formatted in hypertext markup language (HTML) that can contain text, graphic images, multimedia content, and programming elements, such as scripts. Each web site 60 is maintained by a publisher, e.g., an entity that manages and/or owns the web site. For brevity, the term “publisher” will also be used to refer to a web site 60 that is managed and/or owned by the publisher. Similar web sites 70 are maintained by corresponding advertisers, and the term “advertiser” will also be used to refer to a web site 70 that is managed and/or owned by an advertiser.

Publisher client devices 62, advertiser client devices 72 and user client devices 76 are electronic devices that are under the control of user and are capable of requesting and receiving data over the network 52. A client device typically includes a user application, such as a web browser, to facilitate the sending and receiving of data over the network 52, such as requesting a resource (e.g., page content) from a publisher 60 or advertiser 70. Example client devices include personal computers, mobile communication devices, and other devices that can send and receive data over the network 52.

The advertisement management system 74 can provide advertisements of the advertisers 70 for the web pages of the publishers 60. For example, publishers 60 can submit advertisement requests for one or more advertisements to the advertisement management system 74. The advertisement management system 74 responds by sending the advertisements to the requesting publishers 60 for placement on the publishers' web pages, resulting in impressions when the web pages are rendered with the advertisements on the user client devices 76. The advertisements can include embedded links to landing pages, e.g., pages on the advertisers' 70 websites, that a user is directed to when the user clicks an advertisement presented on a publisher web page.

The advertisements provided, and optionally the user responses to the advertisements, are stored in publisher logs 80. The logs 80 store data defining previous impressions delivered for each of particular publisher sites, and user identifier data identifying users that received the impressions. In some implementations, to protect the privacy of users, the advertisement management system anonymizes the impression data for a user so that the data stored in the logs 80 cannot be associated with the user. For example, the identity of the user can be obscured or set to a unique number that is otherwise not associated with the user; and the user's addresses (if known) can be obfuscated to no more than a postal service area, such as a zip code. The logs 80 can also be encrypted so as to further protect user information in the event of unauthorized system access.

Each impression referenced in the log data 80 can be associated with a user identifier (e.g., a user identifier of user, such as an account identifier of a user for a publisher site), a page view identifier that uniquely correlates impressions with the same instance of viewing a page, a time and date of the impression, and one or more demographic and targeted data that may be tracked by the advertisement management system 74 and/or by each corresponding publisher 60. Examples of such attribute data include a user's gender, age, income level, and education level; a location (e.g., zip code, city, and/or country) of the user or client device that requested the web page; and other information that can be tracked by the advertisement management system 74 and/or by the publishers 60. This attribute data can be used for targeting of forecasted impressions.

### §2.0 Inventory Management System

The inventory management system 100 can predict future impressions for a site 60, and the attributes of the future traffic, from the logs 80. Using these forecasted impressions, the inventory management system 100 can provide details about the feasibility of fulfilling future reservations for advertisers in response to reservation queries.

In operation, the inventory management system 100 facilitates negotiations between advertisers and publishers for securing reservations. For example, for a publisher site, a reservation can be negotiated prior to placing the advertisements on the publisher's site. Each reservation specifies (i) a date range during which the advertisements will be displayed, (ii) a number of impressions that will be delivered, (iii) and optionally, other restrictions such as geo targeting or frequency capping metrics.

The inventory management system 100 includes an inventory management engine 110, a number of optional clusters 120, and a log extractor 132. Each cluster 120 includes one or more mixer servers 124 and a plurality of query servers 122. As will be described in more detail below, impression data for each publisher is distributed across each of the query servers 122 by a set of publisher data shards 130. The publisher data shards 130 are sharded by user identifier data so that all impressions for any particular user are processed by only one query server. Sharding of the impression data in this manner facilitates parallel reservation analysis, frequency capping and road blocking, as will be described in more detail below.

Each cluster 120 is preferably a redundant mixer server 124 and query servers 122, and includes the same data in each cluster 120. Use of multiple clusters 120 provides system redundancy and load sharing. In some implementations, cluster configuration data and publisher data is stored as publisher/cluster data 112. The publisher/cluster data 112 specifies the affinity that each cluster should load each publisher, and to maximize caching efficiency, queries for a given publisher are sent to the cluster with the highest affinity available for that publisher. Affinities are distributed uniformly so that when one cluster 120 is unavailable or nearly fully utilized, the load is distributed to the other remaining clusters 120 in a substantially even manner. Although multiple replicated cluster servers may exist, a single selected cluster server performs the requested query processing for any particular reservation query.

The use of multiple clusters 120 is optional. For the remainder of this description, the inventory management system 100 will be described with respect to a single cluster 120. Likewise, the use of multiple mixer servers 124 is also optional. Multiple mixer serves 124 are used primarily for system redundancy, and the inventory management system 100 can be implemented with only one mixer server in each cluster 120. For the remainder of this description, the inventory management system 100 will be described with respect to a single mixer server 124.

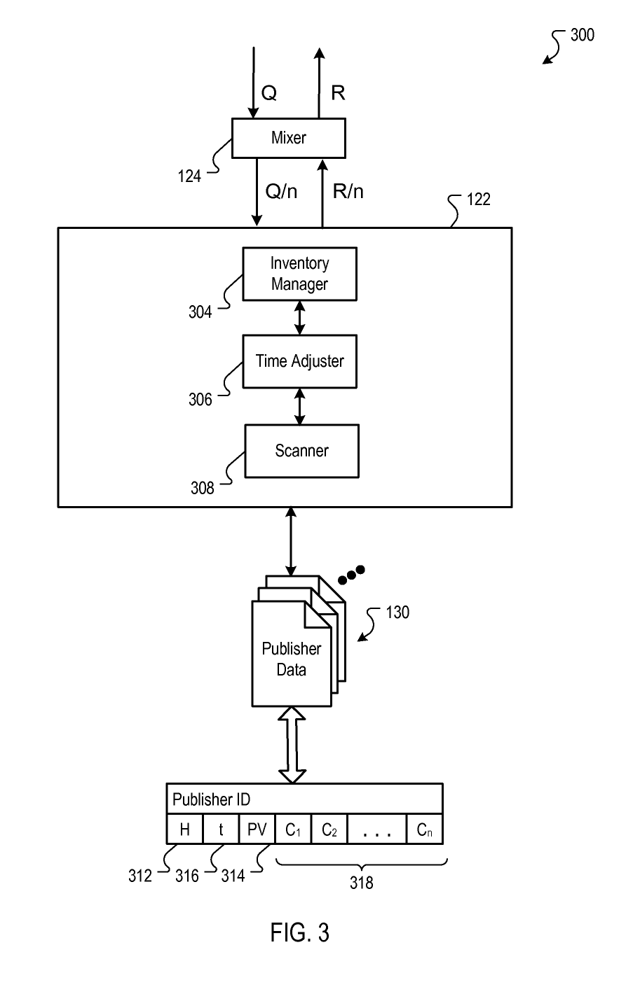

The inventory management engine 110 receives reservation queries from external entities (e.g., publishers, advertisers) and provides the reservation query to the mixer server 124. Each reservation query specifies one or more reservations and includes data specifying, for each of the reservations, a date range for the reservation during which content is to be displayed with a web resource on a publisher site, and a number of requested impressions to deliver during the date range for the reservation. The mixer server 124 translates the reservation query into a plurality of sharded reservation queries, and provides each sharded reservation query to a corresponding query server 122. The sharding of the reservation query is described in more detail in FIG. 3 below.

Each query server 122 receives one of the sharded reservation queries, and determines forecasted impressions for the publisher site from the impression records stored in the publisher data shard. Each forecasted impression specifies an impression time that the forecasted impression occurs. Each query server 122 assigns forecasted impressions that match the sharded reservation query to the one or more reservations, and provides reservation results data specifying the number of forecasted impressions assigned to each of the one or more reservations back to the mixer server 124. The mixer server 124, in turn, aggregates the reservation results data received from the query servers and provides the aggregated reservation results data as a response to the reservation query.

In some implementations, each publisher data shard stores a proper subset of impression records corresponding to a publisher site and a number of user identifiers. Each impression record in a publisher data shard includes user identifier data corresponding to a user identifier and time data specifying a time that an impression was delivered for the publisher site for the corresponding user identifier. Furthermore, all impression records corresponding to the user identifiers in any particular publisher data shard are stored in that particular publisher data shard.

The log extractor 132 creates the publisher data shards from the publisher logs 80. In some implementations, the log extractor 132 the publisher logs 80 defining past impressions delivered on publisher sites and times that each past impression was delivered for a corresponding user identifier. From the publisher logs 80, the log extractor generates publisher data for each publisher. The publisher data for each publisher are impression records representing impressions that occurred for that publisher. Each impression record includes user identifier data corresponding to a user identifier and time data specifying the time that the impression was delivered for the corresponding user identifier.

In some implementations, the logs 80 are processed daily, and daily updates are provided for the publisher data shards 130. With each new daily update, the oldest data for each shard can be discarded. In some implementations, each publisher data shard 130 contains a rolling 28-day history impressions for each publisher. The publisher data shards 130 can include other time windows in other implementations, however. For example, the windows can hourly, e.g., 24 hours and updated hourly; daily; calendar months; or even yearly quarters. In some implementations, the publisher data shards 130 can be updated in near real time so that the publisher data shard 130 includes data defining a time window with data that is less than an hour old, or even a few minutes, old.

In some implementations, the inventory management system 100 also simulates other advertisement serving functionality such as frequency capping or road blocking to predict the success or failure of impression reservations. The simulation results can be used as a baseline for predicting future trends for optimal advertisement delivery.

### §2.1 Sharding Publisher Data

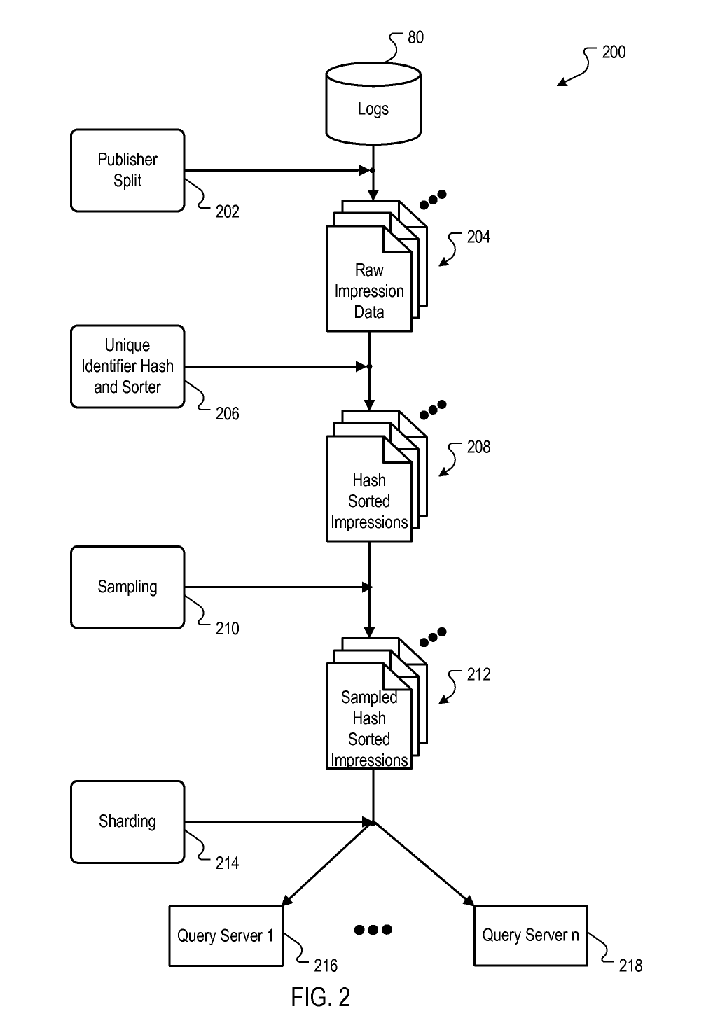

FIG. 2 is a block diagram illustrating a process flow 200 for generating sharded publisher data. The operations in process flow 200 are typically performed in a log extractor, such as the log extractor 132. At some point in time, e.g., once daily, the log extractor 132 selects or receives impressions from publisher logs 80. The impressions may be preprocessed in some manner to, for example, eliminate spam impressions. The impressions may also undergo preliminary formatting if, for example, the impression data is stored in different formats for different publishers.

The log extractor 132 performs a publisher split operation 202. The publisher split operation 202 divides impressions into separate sets of raw impression data 204 for each publisher. The raw impression data 204 is divided for each publisher and includes impression records having a user identifier, page view identifier, an impression time specifying when the impression occurred, and other data of interest that the particular publisher may record. The recorded data of interest may include attributes such as ads shown, ads clicked, age, gender, location, etc. For example, the publisher of a sports related website may record gender and age demographics for its users, while a publisher of a newspaper site may record location and income levels of its users.

The log extractor 132 next performs a user identifier hash and sort operation 206. As used herein, a user identifier can identify a particular user, either explicitly or anonymously, or can identify a particular machine. For example, the user identifier may represent an identity of a user (e.g., a user's account name for a publisher, or a user identifier associated with the user by the advertisement management system 74, or an IP address of a particular client device). The hash operation outputs a hash value of a fixed length for each hashed user identifier.

The operation 206 then sorts the past impressions of the publisher logs by the hashed user identifiers to create hash sorted impressions 208. By sorting on the hashed user identifiers, the impression records are effectively pseudo-randomly sorted based on the user identifiers.

In some implementations, the records are also sorted by secondarily by timestamp and page view. This secondary sorting facilitates a more efficient processing of frequency capping and road blocking. The sorting facilitates an efficient analysis of whether a series impression records for a particular user identifier are within a frequency capping time period and/or the impression records correspond to a page view that meet a road blocking constraint.

The log extractor 132 uses the hash sorted impressions 208 to optionally perform a sampling operation 210. In an example, the sampling operation 210 may sample impressions such that one period (e.g., 28 days) of stored data is limited to a maximum number of impression records for a publisher, e.g., approximately 1 million impressions; or, alternatively, a maximum number of impression records stored in all publisher data shards, e.g., 100,000,000 records. The sampling operation outputs sampled hash sorted impressions 212. If sampling is done, each impression record can include a count value equal to the reciprocal of the sample rate. For example, if every tenth impression record is sample, the count value is 10.

The log extractor 132 uses the sampled hash sorted impressions 212 to perform a sharding operation 214. The sharding operation 214 shards the hashed sorted impression data for each publisher into substantially equal-sized portions so that each query server receives approximately the same number of impression records for each publisher. Each portion or shard can be split amongst a first query server 216 through an nth query server 218.

There are several ways that the sorted impressions 212 (or 208, if sampling is omitted) can be sharded. One way is by dividing the records into exclusive sets of records of substantially equal cardinality. For the sorted impressions 208 for a publisher, a total number q of records in the set can be determined. For each of the n publisher data shards, and an exclusive set of records in the publisher data 208 is selected. Each exclusive set of records has a cardinality of approximately q/n, n being equal to the number of publisher data shards. For example, for a set of 100,000 impression records for 20 publisher data shards, the impression records are selected at the index values of n*100,000/20, where n=1 . . . (20-1). At each selected record, the nearest change in the hashed user identifier value is determined, and the set of records defined by the hashed user identifier changes for two subsequent indices are selected for inclusion in a shard. For example, if that the record 5000 a hashed user index value is 999888333, and record 5002 changes to the hashed user index value of 999888334, then records 1 . . . 5002 would be included in the first publisher data shard. Continuing with this example, if that the record 10000 a hashed user index value is 999888625, and record 9999 changes to the hashed user index value of 999888624, then records 5003 . . . 9999 would be included in the second publisher data shard, and so on. Thus, the set of exclusive set of records for each publisher data shard in a query server includes all records corresponding to the user identifiers in the exclusive set and is exclusive of records in other exclusive sets.

Another way is by taking the modulo of one particular user hash with the desired number of shards. For example, a modulus value of each hash of a corresponding user identifier is determined. The modulus value is of modulo n, being equal to the number of query servers. Each publisher data shard and query server is associated with a corresponding modulo n value, and an impression record in each publisher data shard associated with a corresponding modulo n value is stored in the publisher data shard associated with the value. The impression record includes the hash of the user identifier having the modulus n as the user identifier data, and time data specifying the time that the impression was delivered for the corresponding user identifier. Each publisher data shard associated with a corresponding modulo n value is then provided to the corresponding query server associated with the modulo n value.

For example, if twenty shards are available, the log extractor 132 may divide available publishers by the number of shards and use the modulo to determine which publisher data shard the impression records are stored and which query server (e.g., query server 1 . . . query server n) receives the publisher data shard.

In another implementation, the impressions are sharded by determining user identifier boundaries occurring at a record number that is an approximate multiple of, or an exact multiple of, the number of unique user identifiers divided by the number of shards. The publisher data are broken into shards along the user identifier boundaries. A user identifier boundary is two consecutively sorted impression records that change with respect to a user identifier. For example, if there are 1,000,000 unique user identifiers (or hashes thereof) and 20 query processors, then 20 separate data shards are created by assigning the records indexed by the first 50,000 user identifier hashes (i.e., the number of user identifiers divided by the number of shards) to a first query server, and assigning the records indexed by the next 50,000 user identifier hashes to a second query server, and so on.

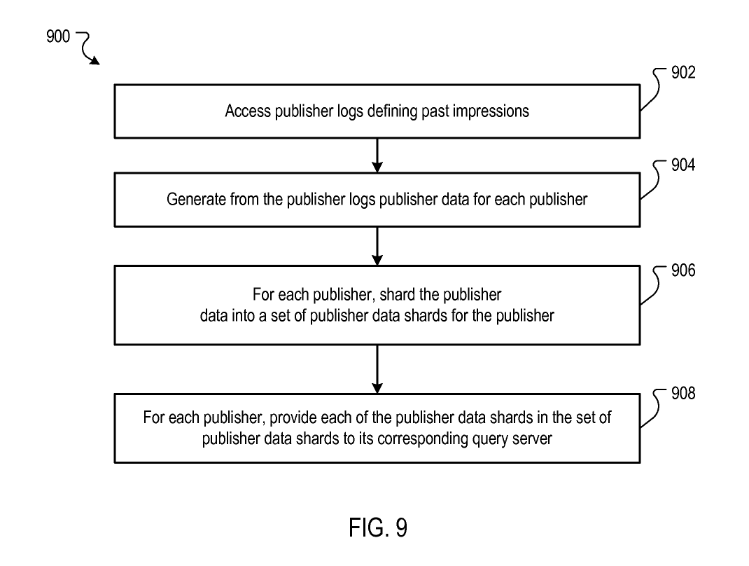

In some implementations, the sharding is performed each day, for the existing month's data for each publisher thus replacing the oldest data (e.g., publisher data shard) with new data. In general, the log extractor 132 generates one publisher data shard table for each query server and for each publisher. In addition, all data shards for each publisher may be packaged into a single publisher data shard. Other sharding methods may be possible. FIGS. 9, 10, and 11 of this specification provide further detail on example sharding methods.

In some implementations, the process of FIG. 2 can first sample impressions for publishers by user identifiers. The sampled impressions can then be sorted by the user identifier, timestamp, and page view sorting keys, and then split into the impression data for each publisher. Other variations of the sorting and processing can also be used.

### §2.2 Reservation Query Processing

FIG. 3 is a block diagram of the mixer 124 and query server 122. The mixer 124 and query server 124 receive a reservation query Q as input and generate a result R as output. The result specifies the number of forecasted impressions assigned to each of the one or more reservations specified by the reservation query Q. As there are n sharded query servers 122, the process described below is performed in each of the n query servers 122 in a cluster 120.

As shown in FIG. 3, the mixer 124 and query server system 122 includes the query server 122, the mixer 124, and publisher data 130. As described above, the reservation query Q is sharded into n sharded reservation queries Q/n. Each reservation specified by the reservation query can specify a targeting (e.g. “Gender=Male AND State=CA”), a size (e.g. 1,000,0000 impressions), and an active period (e.g. from Sep. 2, 2008 to Sep. 15, 2008). Optionally, the reservation can also specify a frequency cap value and/or a road blocking value. Because each of the n sharded query servers 122 processes approximately 1/n of the total number of impressions records for a publisher, the mixer 124 shards the reservation query so that the sharded reservation query specifies approximately the total number of impressions for the reservation by the number of shards. For example, for the reservation query above, each sharded reservation query would include the same targeting data and active period, but the total number of impression for each sharded reservation query would be 50,000 (i.e., 1,000,000/20).

For frequency capping and road blocking however, the values in the reservation query are passed to each sharded reservation query. This is because frequency capping and road blocking are user specific, and thus the values are preserved for use in each query server 122. For example, if the reservation query above had a frequency cap value of 100, each sharded reservation query would also include a frequency cap value of 100.

The scanner 308 reads a publisher data shard for the publisher specified by the query and outputs a stream of past impressions for a given publisher. In some implementations, the publisher data shard 130 is arranged by rows (or records) and columns. Each row corresponds to an impression record. For example, a record may include a column for a hash value attribute 312, a page view attribute 314, a time attribute 316, and a number of other publisher defined attributes C₁-Cₙ 318 that either the publisher 60 or advertisement management system 74 provides.

The hash value attribute column 312 contains a hash of the user identifier of the user or client device that received an impression. The page view attribute column 314 contains a value used to identify a page view instance on which the impression occurred. The time attribute column 316 contains the time at which an impression occurred.

The record may also include a number of other columns. For example, the record may include a count column that contains the number of times the impression should be “counted” because of sampling.

The time adjuster 306 converts the past impressions into future impressions by applying manual adjustments and trending metrics. In some implementations, the time adjuster seasonally shifts the impressions specified in the impression records of the publisher data shard to a future time period to generate the forecasted impressions. For example, for each impression record the time adjuster 306 receives from the impression scanner 308, it selects a week (or an integer multiple of a week) in the future and projects the impression record to that week.

The output of the time adjuster 306 is an impression record projected into the time domain of the simulation. In some implementations, each impression record can be given a weight. In some implementations, the weight may represent the sampling rate of the impression records. Additionally, the weight of each impression record can be multiplied by a factor of the simulated length of weeks (e.g., the time period defined by the reservation) divided by the impression publisher data shard weeks available if the time period defined by the reservation is longer than the number of weeks of data stored in the publisher data shard. This calculation can account for the fact that a relatively short number of weeks of data in the publisher data shard are typically used to simulate a variable length period in the future.

The selection of the week in the future to which the user record is shifted may be a random selection. Additionally, the impression records may be received randomly with respect to their impression times of the forecasted impressions. In some implementations, the forecasted impressions are received by selecting the impression records uniformly at random with respect to their impression times.

Other random selections schemes can also be used. For example, the time adjuster 306 may provide impression records to the inventory manager 304 by (i) distributing impressions according to some mathematical function that is larger at small times and smaller at large times (e.g., an exponential distribution) and/or (ii) assess the variance of the reservations currently in the system and distribute impressions to the time period where the reservations have the greatest variance.

The inventory manager 304 determines a set of matching reservations from the reservation query and a forecasted impression. The set of matching reservations are reservations that the forecasted impression satisfies. For each matching reservation in the set, satisfaction value for each reservation in the set are compare to each other, and the forecasted impression is assigned to one of the reservations in the set of matching reservations based on the comparison of the satisfaction values. The satisfaction value for each reservation is based on a number of forecasted impressions currently assigned to the reservation and the number of requested impressions for the reservation.

The goal of the inventory manager 304 is to assign impressions to reservations in an attempt to satisfy the reservations as much as possible. A reservation is fully satisfied if the number of assigned impressions is greater or equal to its specified number of impressions, or, alternatively, greater than or equal a threshold percentage of the specified number of impressions. As an example, the satisfaction of a reservation may be represented as the ratio between the number of impressions currently assigned to the availability reservation to a total number of forecasted impressions.

Certain types of reservations may not have a maximum number of impressions specified. These reservations are availability reservations. An availability reservation may include data specifying a date range for the reservation during which content is to be displayed with a web resource, for example. Each display of the content can constitute an impression. The availability reservation also include an availability requesting all impressions available during the date range provided in the reservation. In some implementations, the query server 122 calculates a satisfaction value of the availability reservation by determining if a percentage of a total number of forecasted impressions is equal to a number of forecasted impressions processed (e.g., assigned or scanned) for a particular reservation query.

The query server 122 can also determine if a particular reservation is satisfied by determining whether the satisfaction value of the reservation is unity. In addition, if the satisfaction value for a reservation is unity, the query server 122 can preclude assignment of other forecasted impressions to reservations that are fully satisfied.

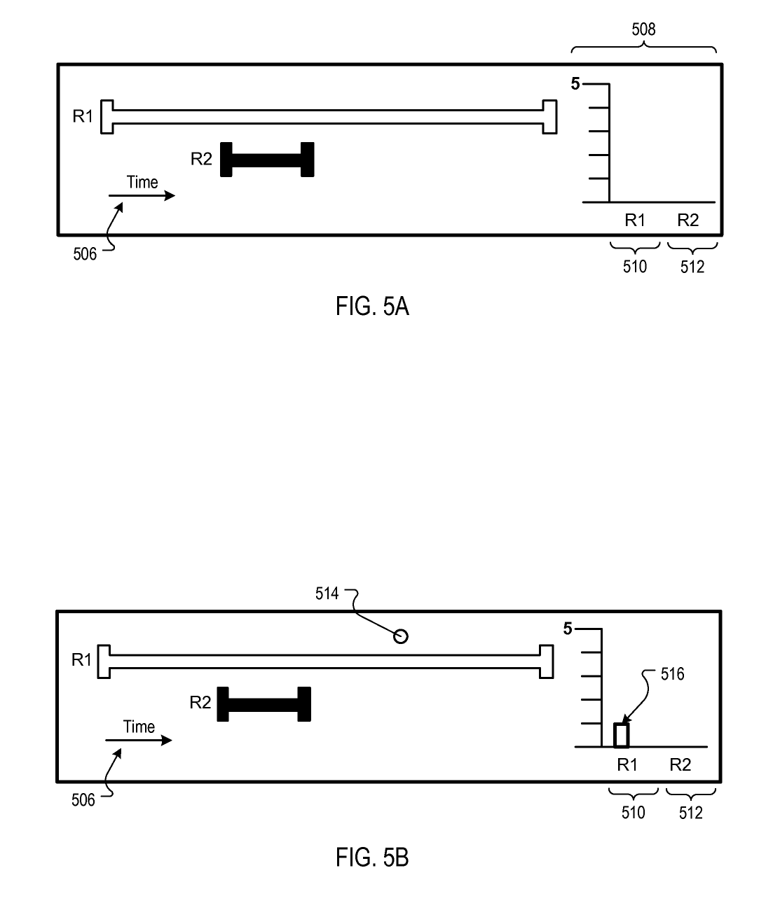

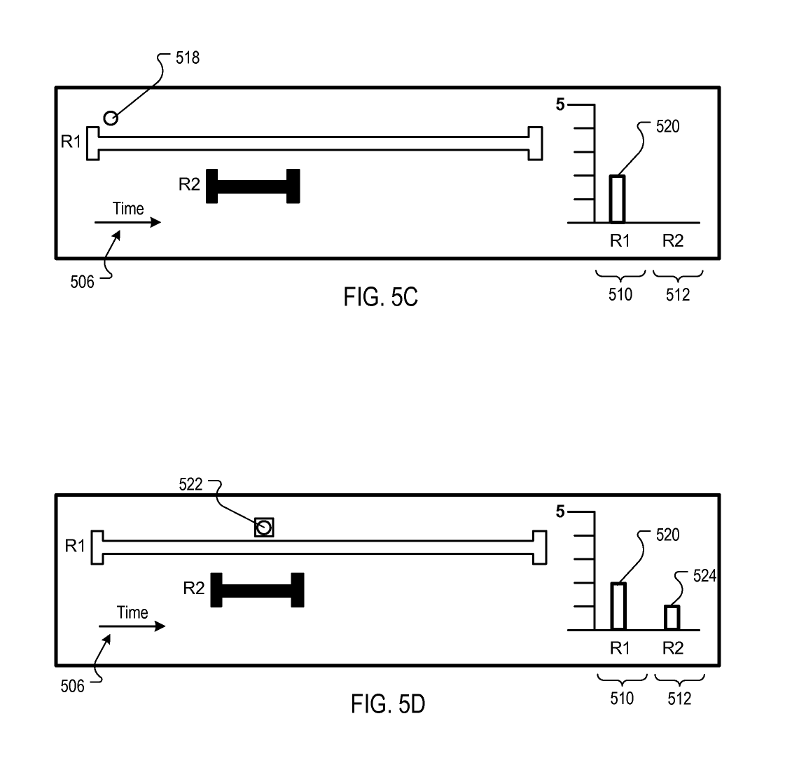

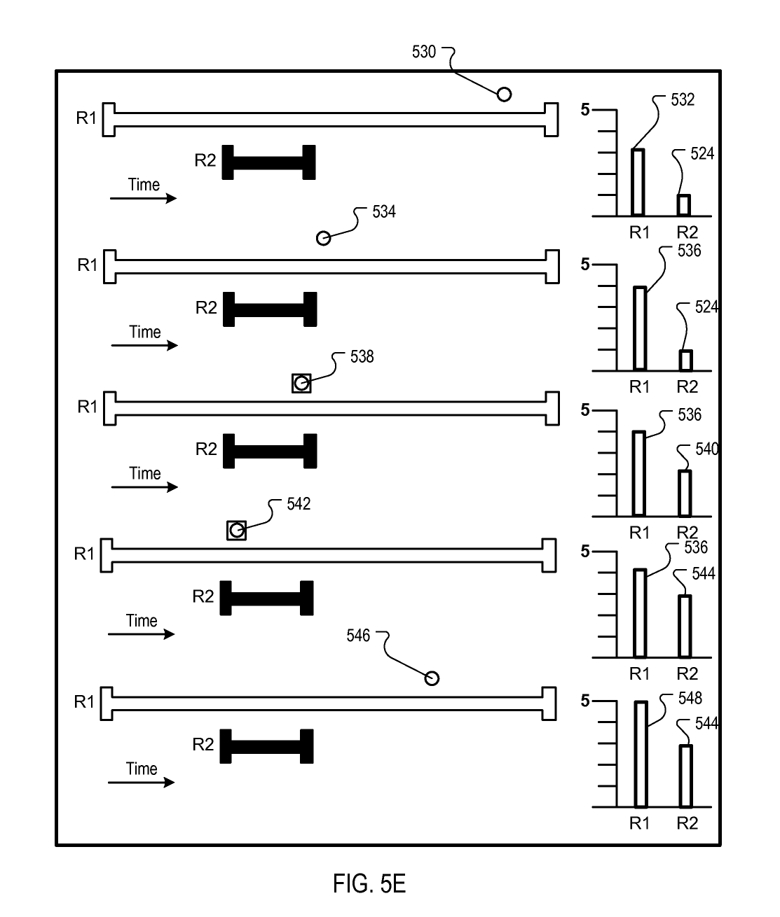

An example assigning impressions to reservations based on satisfaction metrics is described with respect to FIGS. 5A-5E.

### §2.3 Optimization Techniques

In some implementations, the query server 122 employs multiple threads to process a single query. Since queries may occur infrequently, substantial speed can be gained by performing parallel actions, which use some or all of the CPU cores available to the query server 122. In another example, the scanner 308 can also employ multi-threaded scan support in a particular library function. In particular, when scanning a data table, the scanner 308 can divide the rows into as many consecutive blocks as there are CPU cores available to the process and then can delegate the scanning of each block to a separate thread. Each thread reads the rows it is responsible for, evaluates the set of reservations matching those rows, groups the rows into objects, projects the sequences into the future (e.g., within the time adjuster 306), and passes the sequences to the inventory manager 304.

Once the sharded reservation query is processed, the inventory manager 304 provides to the mixer server 124 reservation results data (R/n) specifying the number of forecasted impressions assigned to each of the one or more reservations. The mixer server 124 receives the reservation results data (R/n) from each of the n query servers 122 and aggregates the results into aggregated reservation results data R. The aggregated result R is then provided as a response to the reservation query.

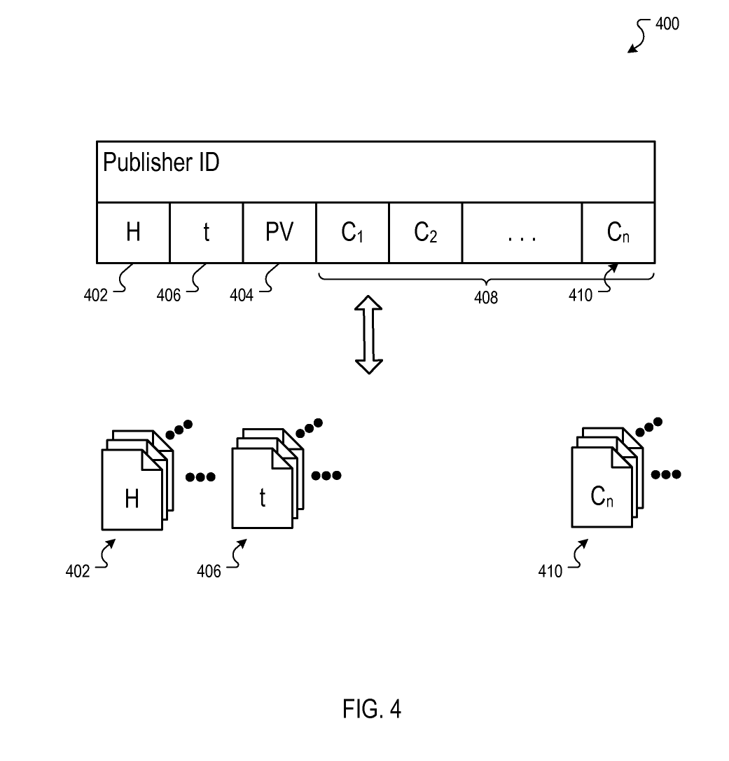

FIG. 4 is a block diagram of a file storage structure 400 for sharded publisher data at a query server. The file storage structure 400 represents a publisher data shard for storing past impression data. The structure 400 typically contains a sample of a particular publisher's past impressions over a set of past dates (e.g. the last 28 days). In this example, the structure 400 includes hash value attribute column 402, a page view attribute column 404, a time attribute column 406, and a number of other publisher defined attributes 408. In operation, query servers 122 may read any portion of the structure 400. For example, if a particular query simply requests a hash value, a page view value, and a count value, the query servers 122 can retrieve only information in columns 402, 404, and 410. Thus, the query server 122 would not be required to retrieve the entire file storage structure 400.

An increase in system performance and optimization can be achieved by simulating the execution of partial read, write, or update algorithms. For example, data in the columns for publisher data shards can be stored in separate files on a local disk. During table scanning, the scanner 308 may then read only the subset of the columns for which it requires values, thus saving substantial CPU and input and output time.

In another implementation, further system optimization can be achieved by compressing each column file. The compression can collapse unused columns or columns missing information, for example. This organization can provide both optimal compression for rarely-used attributes and a desirable method to add new attributes on the fly.

### §2.4 Assigning Impressions to Reservations

FIGS. 5A-5E are block diagrams illustrating assignment of impressions to reservations according to a satisfaction values. The example impression assignments depicted in FIGS. 5A-5E can be performed in the inventory manager 304, for example. In some implementations, the assignment of impressions to reservations can be performed to provide optimized impression assignment using satisfaction metrics and randomization techniques. In some implementations, the inventory manager 304 receives the forecasted impressions randomly with respect to their times and allocates impressions to reservations with the lowest value for a particular satisfaction metric.

In some implementations, the satisfaction metric is represented by a number of assigned impressions divided by the total number of requested impressions. This may provide the advantage of allocating impressions to reservations in subspaces (both time and targeting) where contention may be the lowest. As such, the inventory manager 304 can calculate an approximation of a maximum number of available impressions and provide a plan that attempts to achieve this number.

As shown in FIG. 5A, reservations R1 and R2 are graphed over a particular time 506. For simplicity, only five impressions are represented on a scale 508 for each diagram and only five impressions are specified for each reservation R1 and R2. Furthermore, each impression pertains to time based analysis, however, in practice, any number of impressions can be represented over variables other than time. The scale 508 includes a column 510 and a column 512 indicating the satisfaction of each reservation for R1 and R2, respectively. Initially both columns 510 and 512 are empty indicating that both reservations have a satisfaction value of zero, as no impression are assigned to either reservation.

As shown in FIG. 5B, the reservations R1 and R2 are depicted in a graph over time 506. An impression 514 that matches both R1 and R2 is received randomly with respect to its time. In some implementations, the impressions for a set of reservations are received randomly with respect to the time period that is defined by the individual time periods of all of the reservations in the set of reservations. For example, the impression 514 is for a time that is randomly selected from within the period specified by the impression R1, as this time period includes the time period specified by the reservation R2.

Since the reservation R1 is much longer than the reservation R2, the impression is more likely to overlap with reservation R1 and not overlap with reservation R2. Here, the impression 514 only overlaps with R1 and thus is assigned to reservation R1 and the column 510 is updated to a satisfaction value 516 of (⅕). For example, one reservation out of a total of five reservations is assigned to R1 in column 510 (FIG. 5B).

As shown in FIG. 5C, a second impression 518 that matches both R1 and R2 is received randomly with respect to its time. The second impression 518 is received outside of the reservation time allotted to reservation R2 and is therefore assigned to the reservation R1. As such, the column 510 is updated to a satisfaction value 520 of (⅖).

As shown in FIG. 5D, a third impression 522 that satisfies both R1 and R2 is received randomly with respect to its time. The third impression 522 overlaps with both reservations R1 and reservation R2. The inventory manager 304 can ensure that an overlapping impression 522 is assigned to the reservation with the lower satisfaction value. In this example, the reservation R1 has a satisfaction value of (⅖) and the reservation R2 has a satisfaction value of ( 0/5). Thus, the inventory manager 304 assigns the new impression 522 to the reservation R2. Accordingly, the column 510 remains at a satisfaction value 520 (e.g., 2 out of 5 impressions) and the column 512 is updated to a satisfaction value 524 (e.g., 1 out of 5 impressions)

The process of assigning impressions to the least satisfied, eligible reservation can be repeated as shown in FIG. 5E. In particular, a fourth impression 530 is received at a random time. Since the impression 530 does not overlap time available for reservation R2, the impression is assigned to the reservation R1. Thus, the inventory manager 304 assigns the new impression 530 to the reservation R1 and updates the column 510 to a satisfaction value 532 (e.g., 3 out of 5 impressions). The column 512 remains at a satisfaction value 524 (e.g., 1 out of 5 impressions).

In a similar fashion, a fifth impression 534 is received, which does not overlap time available for reservation R2. Thus, the inventory manager 304 assigns the new impression 534 to the reservation R1 and updates the column 510 to a satisfaction value 536 (e.g., 4 out of 5 impressions). The column 512 remains at a satisfaction value 524 (e.g., 1 out of 5 impressions).

Next, a sixth impression 538 is received at a random time. The sixth impression 538 overlaps the time available for reservation R2. Thus, the inventory manager 304 assigns the new impression 538 to the reservation R2 and updates the column 512 to a satisfaction value 540 (e.g., 2 out of 5 impressions). The column 510 remains at a satisfaction value 536 (e.g., 4 out of 5 impressions).

In a similar fashion, a seventh impression 542 is received at a random time. The seventh impression 542 overlaps the time available for reservation R2. Thus, the inventory manager 304 assigns the new impression 542 to the reservation R2 and updates the column 512 to a satisfaction value 544 (e.g., 3 out of 5 impressions). The column 510 remains at a satisfaction value 536 (e.g., 4 out of 5 impressions).

Finally, an eighth impression 546 is received, which does not overlap time available for reservation R2. Thus, the inventory manager 304 assigns the new impression 546 to the reservation R1 and updates the column 510 to a satisfaction value 548 (e.g., 5 out of 5 impressions). The column 512 remains at a satisfaction value 544 (e.g., 3 out of 5 impressions).

The final graph of the satisfaction values 544 and 548 depicts the result after the inventory manger 304 assigned the eight randomly received impressions (514, 518, 522, 530, 534, 538, 542, and 546). In this example, all impressions eligible for the reservation R2 have been assigned to R2. The reservation R2 has not been completely satisfied because of the narrower time constraint R2. In practice, the reservation R1 may receive a few impressions that would typically be assigned to reservation R2 due to fluctuations in the satisfaction. In general, the more difficult the reservation R2 is to meet, the lower the chances are that the reservation R1 will “steal” impressions from it.

In some implementations, the inventory management system 100 can also take into account one or more throttling constraints when forecasting impressions. For example, some advertisers that are budget constrained may have their advertisements throttled, i.e., omitted from selection, at certain times per day on a daily basis, or randomly throttled on a daily basis according to a random selection technique. Such throttling facilitates spreading a budget allocation throughout a period so that the advertiser does not spend its entire budget for the period well before the period ends. By taking throttling into account, the inventory management system 100 can help advertisers and publishers determine the feasibility of reservations for advertisements that are also throttled.

In some implementations, the inventory management system 100 can also take into account reservations already purchased from a publisher during a time period. By taking into account the purchased reservations, the inventory management system 100 can adjust the forecasted impressions to discount for the unavailable impressions. For example, suppose the inventory management system 100 forecasts 1,000,000 impressions for a particular publisher for a 1-month period in the future. Of the 1,000,000 impressions, 600,000 of those impressions are male users, and 400,000 are female users. Suppose also that an advertiser has purchased a reservation for 100,000 impressions for female users, and 50,000 impressions for male users for the 1-month period from that publisher. With this information, the inventory management system 100 can adjust the available forecasted impressions to 300,000 female users and 550,000 male users for the 1-month period.

In variations of this implementation, the inventory management system 100 can further facilitate the purchasing of reservations from publishers. For example, suppose a second advertiser, by utilizing the inventory management system 100, determines that a reservation for 250,000 impressions for male users during the 1-month period is feasible. By use of the inventory management system, the advertiser can contact the publisher and request to purchase the reservation. If the advertiser and publisher agree to terms and a purchase is made, the inventory management system will adjust downward by 250,000 the male impressions for the 1-month period. Furthermore, the inventory management system 100 can provide the reservation purchase information to the advertisement management system 74, and advertisements for the advertiser will be served on the publisher pages in accordance with the reservation.

### §3.0 Example Processes

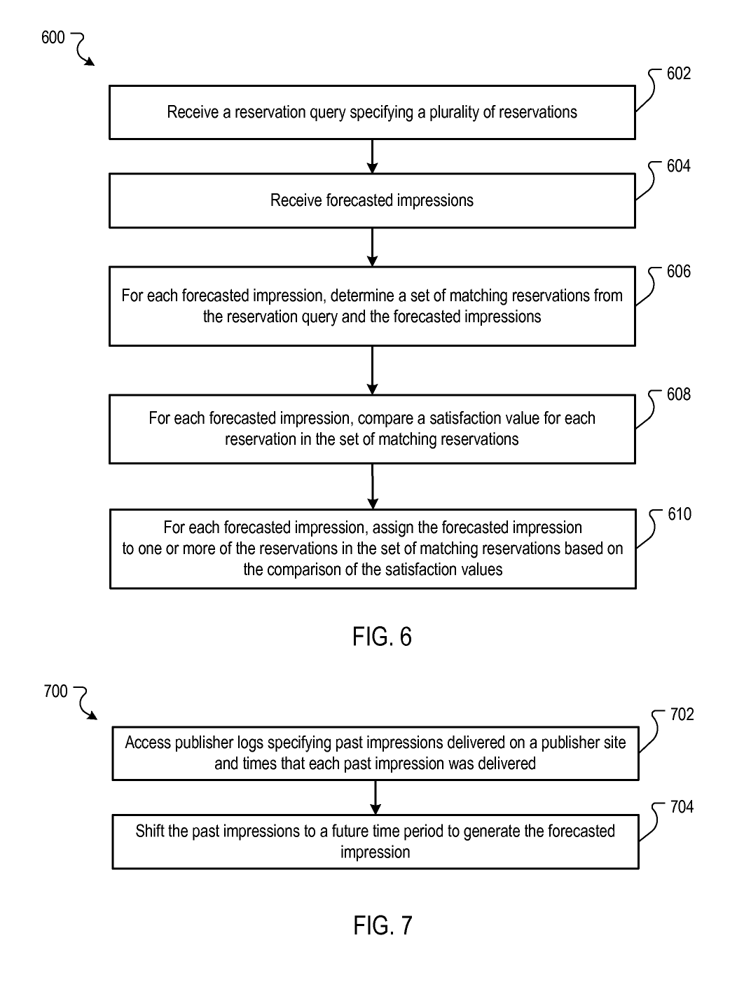

FIG. 6 is a flow diagram of an example process 600 for assigning impression reservations according to satisfaction values. The process 600 can, for example, be implemented in a query server 122.

The process 600 receives a reservation query specifying a number of reservations (602). For example, the inventory management engine 110 receives a reservation query that includes data specifying a number of reservations. The reservation query can be sent by any one of the publisher web site 60, the publisher client device 62, the advertiser web site 70, or the advertiser client device 72. The reservations include data specifying a date range for each reservation during which content is to be displayed with a web resource. Each display of the content constitutes an impression. The reservations also include a number of requested impressions to deliver during the date range for each reservation.

The process 600 receives forecasted impressions (604). For example, the time adjuster 306 can provide the forecasted impressions and the inventory manager can select the forecasted impressions in random order with respect to the impression times of the forecasted impressions.

The process 600 determines a set of matching reservations using the reservation query and the forecasted impressions (606). For example, the query server 122 determines a set of matching reservations using targeting criteria to determine a correlation between the reservation query and the forecasted impressions. For every impression in the received input, the query server 122 determines a set of reservations that the impression matches. An impression matches a reservation if it matches the reservation targeting filter and the timestamp of the impression falls during the period of time the reservation specifies.

For each forecasted impression, the process 600 compares a satisfaction value for each reservation in the set of matching reservations (608). For example, a satisfaction value may be calculated by the inventory manager 304 by determining a ratio of the number of impressions currently assigned to the reservation to the number of requested impressions for the reservation. The satisfaction values for each reservation in the set are compared.

For each forecasted impression, the process 600 assigns the forecasted impression to one or more of the reservations in the set of matching reservations based on the comparison of the satisfaction values (610). For example, the inventory manager 304 assigns the impression to the reservation in the set of matching reservations that currently has the lowest satisfaction.

FIG. 7 is a flow diagram of an example process 700 for forecasting impressions. The process 700 can, for example, be implemented in the log extractor 132 and the query server 122.

The process 700 accesses publisher logs specifying past impressions delivered on a publisher site and also accesses times that each past impression was delivered (702). For example, the log extractor 132 accesses publisher logs 80 to retrieve past impressions on a particular publisher web site 60. In general, an impression matches a reservation if the impression matches the reservation targeting filter (as pre-computed by the scanner 308, for example) and the timestamp of the impression falls during the period of time specified by the reservation.

The process 700 shifts the past impressions to a future time period to generate the forecasted impressions (704). For example, the time adjustor 306 shifts the past impression by an integer multiple of a week. The shift can be seasonal, i.e., with the season being a week, two weeks, a month, a quarter, etc. In particular, the time adjustor 306 may output an impression record (e.g., user identifier, pages, and impressions) that is projected into the time domain of an impression simulation. The projection may be hours, days, weeks, months, etc.

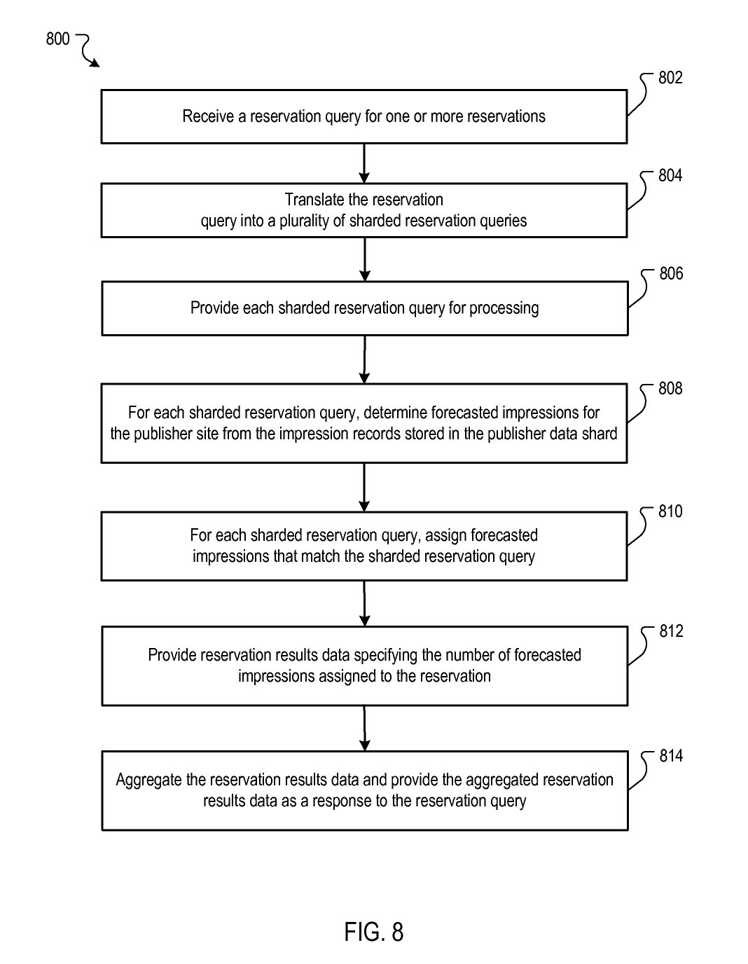

FIG. 8 is a flow diagram of an example process 800 for processing a reservation query. The process 800 can, for example, be implemented in a query server 122.

The process 800 receives a reservation query for one or more reservations (802). For example, the mixer 124 receives a reservation query (Q) that includes data specifying a date range for the reservation during which content is to be displayed with a web resource. The reservation query includes a number of requested impressions to deliver during the date range for the reservation and a publisher identifier identifying a publisher site hosting the web resource. In some implementations, the reservation query includes a frequency cap value for the reservation, which specifies a maximum number of impressions for a user identifier during a particular date range.

The process 800 translates the reservation query into a plurality of sharded reservation queries (804). For example, the mixer 124 translates the reservation query to a query server 122. In particular, the translation may involve specifying, for each of the one or more reservations, a number of requested impressions to deliver during the date range for the reservation for each sharded query equal to the number of requested impressions for the reservation divided by the number of query servers. In some implementations, translating the reservation query into sharded reservation queries may include specifying a frequency cap value for each sharded query equal to the frequency cap value of the reservation query.

The process 800 provides the sharded reservation query for processing (806). For example, the mixer 124 forwards the translated request to a particular query server 122. The query server 122 can store impression data, such as impression records for particular publishers. Impression records may be stored as rows of information in data stores. Impression records include attribute data defining a number of attributes associated with a particular user identifier, user data corresponding to a user identifier data, and time data. The content of each column in the impression records can be stored in a number of query servers 122.

For each sharded reservation query, the process 800 determines forecasted impressions for the publisher site from the impression records stored in the publisher data shard (808). For example, the query server 122 computes forecasted impression estimates for the delivery of the reservations. To determine or generate forecasted impressions, the query server 122 may seasonally shift the impressions specified in the impression records of the publisher data shard to a future time period. In some implementations, the query server 122 can determine forecasted impressions for the publisher site from the impression records stored in the publisher data shard by accessing only the respective data files corresponding to columns that are relevant to the targeting data of the sharded reservation query. In this fashion, the process 800 saves substantial CPU processing and time by reading only a subset of the columns for which it desires values.

For each sharded reservation query, the process 800 assigns the forecasted impressions to reservations that match the sharded reservation query (810). The assignments may be performed by the query server 122. Assigning forecasted impressions that match the sharded reservation query to the one or more reservations can include (i) determining a set of matching reservations from the sharded reservation query and a forecasted impression for each forecasted impression and (ii) comparing a satisfaction value for each reservation in the set of matching reservations and (iii) assigning the forecasted impression to one of the reservations in the set of matching reservations based on the comparison of the satisfaction values. The satisfaction value may be based on a ratio of forecasted impressions currently assigned to the reservation and the number of requested impressions specified by the sharded reservation query. In some implementations, assigning forecasted impressions that match the sharded reservation query to the one or more reservations may include randomly selecting a forecasted impression with respect to the impression times.

For each sharded reservation query, the process 800 provides the reservation results data specifying the number of forecasted impressions assigned to the reservation (812). For example, the query server 122 can provide reservation results specifying, for one or more reservations, the sum of the impression counts of the forecasted impressions assigned to each of the reservations by that query server. In general, each forecasted impression specifies an impression count and the number of forecasted impressions assigned to a reservation is equal to the sum of the impression counts of the forecasted impressions assigned to the reservation.

The process 800 aggregates the reservation results data and provided as a response to the reservation query (814). For example, the aggregated reservation results are sent to the mixer 124 in a response (R). The response (R) can, for example, be sent to an entity accessible to network 52, or another entity. In the event that the reservation query included a frequency cap value, the query server 122 may assign no more than a maximum number of impressions corresponding to any user identifier.

FIG. 9 is a flow diagram of an example process 900 for generating publisher data shards. The process 900 can be implemented in the log extractor 132. As described above, data shards represent data tables which can store a subset of impression records corresponding to a publisher site and a number of user identifiers.

The process 900 accesses publisher logs that define past impressions (902). For example, the log extractor 132 accesses publisher logs 80 to retrieve past impression data. The publisher logs 80 include (i) past impression information regarding the delivery of impressions on publisher sites and (ii) times that each past impression was delivered for a particular user identifier.

The process 900 generates from the publisher logs publisher data for each publisher (904). For example, log extractor 132 generates publisher data files for each publisher available in the publisher logs 80. In general, the publisher data in each publisher data file includes impression records, a user identifier, and time data. The impression records represent individual impressions for a particular user. The user identifier data represents one or more users or client devices for each impression. The time data represents the time that the impressions were delivered for a corresponding user identifier.

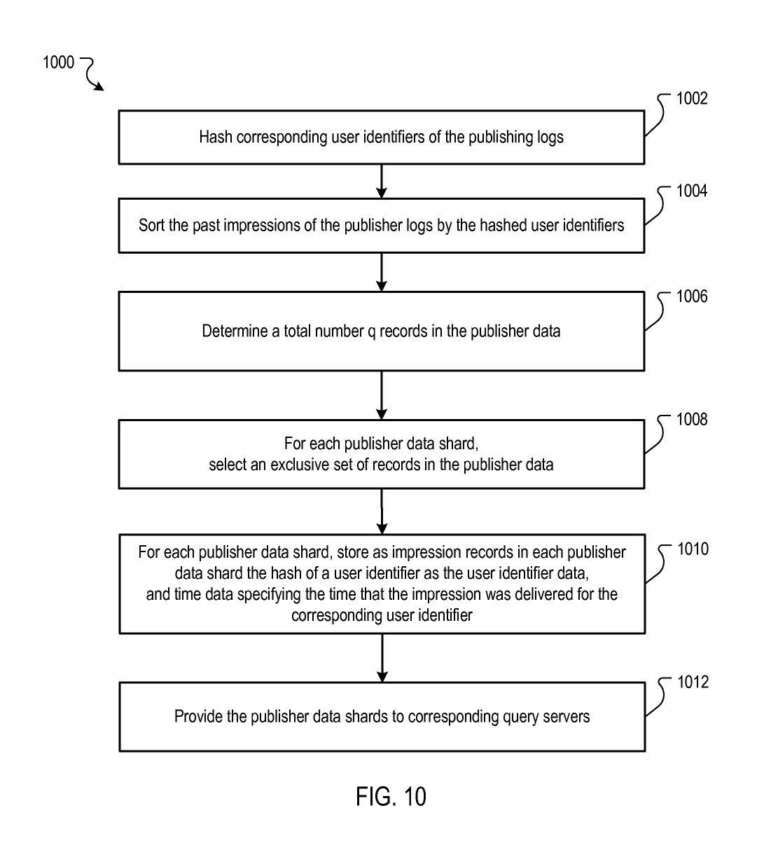

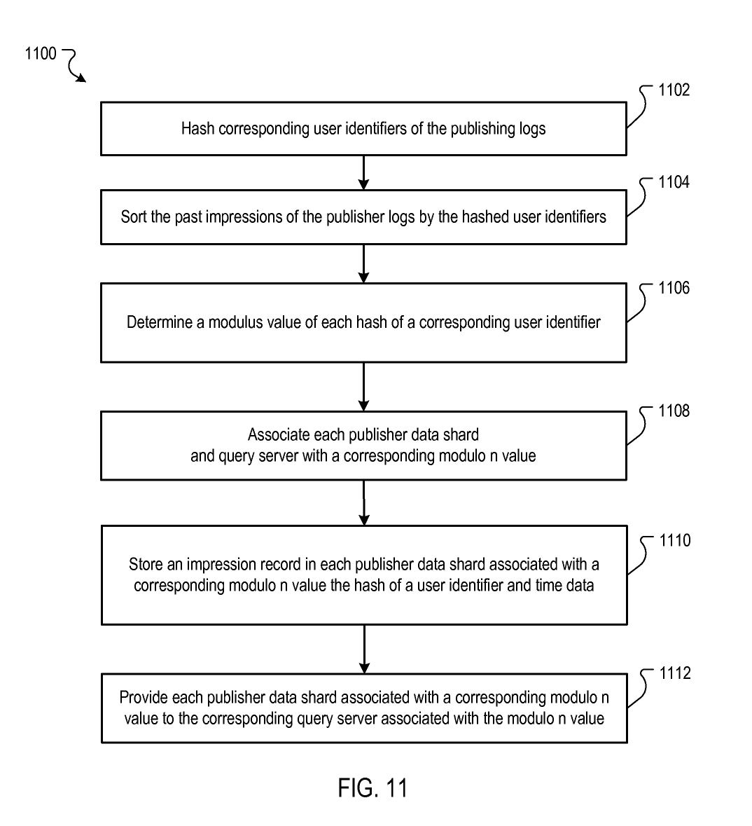

The process 900 shards the publisher data into a set of publisher data shards for each publisher (906). For example, the log extractor 132 shards the data for each publisher into substantially equal-sized portions. Example processes of sharding the data into substantially equal-sized portions are described in FIGS. 10 and 11.

For each publisher, the process 900 provides each publisher data shard in the set of publisher data shards to a corresponding query server (908). For example, the log extractor 132 provides a publisher data shard (e.g., a (publisher, shard) pair) to a corresponding query server 122.

FIG. 10 is a flow diagram of an example process 1000 for generating publisher data shards by determining a nearest hash index change. The process 1000 can be implemented in the log extractor 132.

The process 1000 hashes corresponding user identifiers of the publishing logs (1002). For example, the log extractor 132 generates a user hash from a user identifier stored in a received cookie, or from other information.

The process 1000 sorts the past impressions are by the hashed user identifiers (1004). For example, the log extractor 132 sorts impressions by user-hash, using page-view as a secondary key.

The process 1000 begins to shard publisher data into a set of publisher data shards for a specific publisher by determining a total number of records (q) in the publisher data (1006).

Next, the process 1000 selects an exclusive set of records in the publisher set (1008). For example, for each publisher data shard, the log extractor 132 selects a set of records with a cardinality of approximately (q/n), (n) being equal to the number of publisher data shards. The selections indices occur at the breaks in the hashed user identifiers nearest to each index corresponding to a q/n selection point. In general, the exclusive set of records for the query server includes all records corresponding to the user identifiers in the exclusive set and is exclusive of records in other exclusive sets.

For each publisher data shard, the process 1000 stores a hash of a user identifier and the time data as an impression record (1010). For example, the log extractor 132 stores the hashed user identifier, the time data, and other attribute data in each impression record.

The process 1000 provides the publisher data shards to corresponding query servers upon request (1012). For example, the log extractor 132 provides n publisher data shard to n corresponding query servers.

FIG. 11 is a flow diagram of an example process 1100 for generating publisher data shards by a modulus of a hashed identifier. The process 1100 can be implemented in the log extractor 132.

The process 1100 hashes corresponding user identifiers of the publishing logs (1102). For example, the log extractor 132 generates a user hash from a user identifier stored in a received cookie, or from other information.

The past impressions are then sorted by the hashed user identifiers (1104). For example, the log extractor 132 sorts impressions by user-hash, using page-view as a secondary key.

The process 1100 determines a modulus value of each hash of a corresponding user identifier (1106). For example, the log extractor 132 may calculate a modulo value (n) of a particular user-hash, with n being the number of data shards.

The process 1100 uses the modulo value (n) to associate each publisher data shard to a query server (1108). For example, the log extractor can associate a publisher data shard and a query server with a value of 0; and associated another publisher data shard and another query server with a value of 1, etc.

The process 1100 stores an impression record in each publisher data shard (associated with a corresponding module value (n)) the hash of a user identifier and time data (1110). For example, the query server 122 can store an impression record having a user identifier that that corresponds to a modulo n value of 0 in a publisher data shard associated with the value of 0.

The process 1100 provides each publisher data shard associated with a corresponding modulo value (n) to the corresponding query server associated with the module value (n) (1112). For example, for modulo n values of 0, the log extractor 132 can provide the corresponding publisher data shard associated with the value of 0 to the query server associated with the value of 0. Likewise, for modulo n values of 1, the log extractor 132 can provide the corresponding publisher data shard associated with the value of 1 to the query server associated with the value of 1, and so on.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and an apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data and receiving user input from a user interacting with the client device). Data generated at the client device (e.g., a result of the user interaction) can be received from the client device at the server.

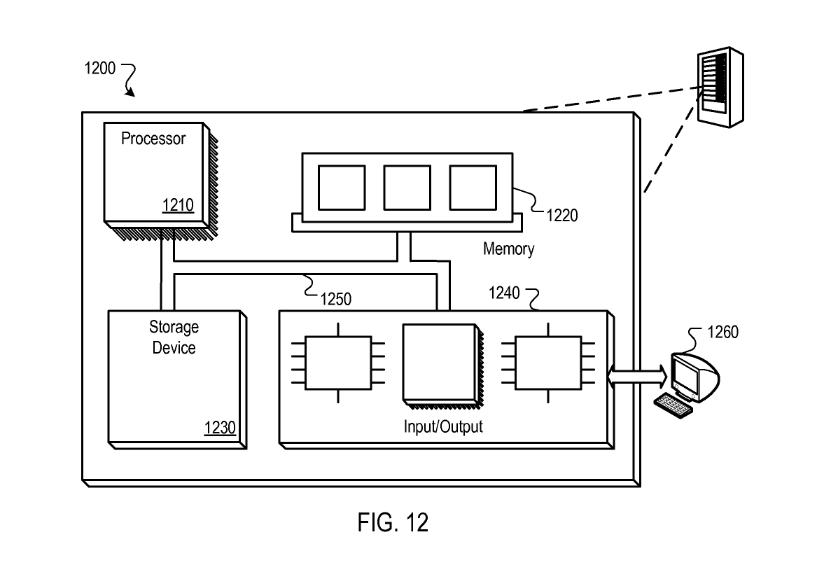

An example of one such type of computer is shown in FIG. 12, which shows a block diagram of a programmable processing system (system). The system 1200 that can be utilized to implement the systems and methods described herein. The architecture of the system 1200 can, for example, be used to implement a computer client, a computer server, or some other computer device.

The system 1200 includes a processor 1210, a memory 1220, a storage device 1230, and an input/output device 1240. Each of the components 1210, 1220, 1230, and 1240 can, for example, be interconnected using a system bus 1250. The processor 1210 is capable of processing instructions for execution within the system 1200. In one implementation, the processor 1210 is a single-threaded processor. In another implementation, the processor 1210 is a multi-threaded processor. The processor 1210 is capable of processing instructions stored in the memory 1220 or on the storage device 1230.

The memory 1220 stores information within the system 1200. In one implementation, the memory 1220 is a computer-readable medium. In one implementation, the memory 1220 is a volatile memory unit. In another implementation, the memory 1220 is a non-volatile memory unit.

The storage device 1230 is capable of providing mass storage for the system 1200. In one implementation, the storage device 1230 is a computer-readable medium. In various different implementations, the storage device 1230 can, for example, include a hard disk device, an optical disk device, or some other large capacity storage device.

The input/output device 1240 provides input/output operations for the system 1200. In one implementation, the input/output device 1240 can include one or more of a network interface device, e.g., an Ethernet card, a serial communication device, e.g., and RS-232 port, and/or a wireless interface device, e.g., an 802.11 card. In another implementation, the input/output device can include driver devices configured to receive input data and send output data to other input/output devices, e.g., keyboard, printer and display devices 1260.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving at a mixer server a reservation query for one or more reservations, the reservation query including, for each of the one or more reservations, data specifying a date range for the reservation during which content is to be displayed with a web resource, a number of requested impressions to deliver during for the reservation during the date range, and a publisher identifier identifying a publisher site hosting the web resource;
translating at the mixer server the reservation query into a plurality of sharded reservation queries and providing each sharded reservation query from the mixer server to a corresponding query server, wherein:
each query server processes an associated publisher data shard;
each publisher data shard stores a proper subset of impression records corresponding to the publisher site and a plurality of user identifiers, each impression record including user identifier data corresponding to a user identifier and time data specifying a time that an impression was delivered for the publisher site for the corresponding user identifier, and all impression records corresponding to the user identifiers are stored in the publisher data shard;
at each query server:
determining forecasted impressions for the publisher site from the impression records stored in the publisher data shard, each forecasted impression specifying an impression time that the forecasted impression occurs;
assigning forecasted impressions that match the sharded reservation query to the one or more reservations; and
providing reservation results data specifying the number of forecasted impressions assigned to each of the one or more reservations to the mixer server; and
aggregating at the mixer server the reservation results data received from the query servers and providing the aggregated reservation results data as a response to the reservation query.

2. The computer-implemented method of claim 1, further comprising:
accessing at a log server publisher logs defining past impressions delivered on publisher sites and times that each past impression was delivered for a corresponding user identifier;
generating from the publisher logs publisher data for each publisher, the publisher data for each publisher comprising impression records, each impression record representing an impression and including user identifier data corresponding to a user identifier and time data specifying the time that the impression was delivered for the corresponding user identifier;
for each publisher:
sharding the publisher data into a set of publisher data shards for the publisher;
providing each of the publisher data shards in the set of publisher data shards to its corresponding query server.

3. The computer-implemented method of claim 2, wherein:
generating from the publisher logs publisher data for each publisher comprises hashing the corresponding user identifiers of the publishing logs and sorting the past impressions of the publisher logs by the hashed user identifiers; and
sharding the publisher data into a set of publisher data shards for the publisher comprises:
determining a total number q of records in the publisher data;
for each of the publisher data shards:
selecting an exclusive set of records in the publisher data, wherein the exclusive set of records has a cardinality of approximately q/n, n being equal to the number of publisher data shards, and wherein the exclusive set of records for the query server includes all records corresponding to the user identifiers in the exclusive set and is exclusive of records in other exclusive sets; and
storing as impression records in each publisher data shard the hash of a user identifier as the user identifier data, and time data specifying the time that the impression was delivered for the corresponding user identifier; and
providing the publisher data shards to corresponding query servers.

4. The computer-implemented method of claim 3, wherein generating from the publisher logs publisher data for each publisher further comprises sorting the past impressions of the publisher logs secondarily by time data and page view data.

5. The computer-implemented method of claim 2, wherein:
generating from the publisher logs publisher data for each publisher comprises hashing the corresponding user identifiers of the publishing logs and sorting the past impressions of the publisher logs by the hashed user identifiers; and
sharding the publisher data into a set of publisher data shards for the publisher comprises:
determining a modulus value of each hash of a corresponding user identifier, wherein each modulus value is modulo n, and wherein n is equal to the number of query servers;
associating each publisher data shard and query server with a corresponding modulo n value;
storing as an impression record in each publisher data shard associated with a corresponding modulo n value the hash of a user identifier having a modulus n as the user identifier data, and time data specifying the time that the impression was delivered for the corresponding user identifier; and
providing each publisher data shard associated with a corresponding modulo n value to the corresponding query server associated with the modulo n value.

6. The computer-implemented method of claim 2, wherein:
generating from the publisher logs publisher data for each publisher comprises hashing the corresponding user identifiers of the publishing logs and sorting the past impressions of the publisher logs by the hashed user identifiers and time data; and
sharding the publisher data into a set of publisher data shards for the publisher comprises:
determining a total number q of unique hashed user identifiers for the publisher;
for each of the publisher data shards:
selecting an exclusive set of records in the publisher data, wherein the exclusive set of records includes q/n unique hashed user identifiers, n being equal to the number of publisher data shards, and wherein the exclusive set of records for the query server includes all records corresponding to the user identifiers in the exclusive set and is exclusive of records in other exclusive sets; and
storing as impression records in each publisher data shard the hash of a user identifier as the user identifier data, and time data specifying the time that the impression was delivered for the corresponding user identifier; and
providing the publisher data shards to corresponding query servers.

7. The computer-implemented method of claim 1, wherein:
the reservation query includes a frequency cap value for a reservation specifying maximum number of impressions for a user identifier during the date range; and
assigning forecasted impressions that match the sharded reservation query to the one or more reservations comprises assigning to the reservation no more than the maximum number of impressions corresponding to any user identifier.

8. The computer-implemented method of claim 7, wherein translating the reservation query into the plurality of sharded reservation queries comprises specifying, for each of the one or more reservations, a number of requested impressions to deliver during the date range for the reservation for each sharded query equal to the number of requested impressions for the reservation divided by the number of query servers.

9. The computer-implemented method of claim 8, wherein translating the reservation query into the plurality of sharded reservation queries comprises specifying a frequency cap value for each sharded query equal to the frequency cap value of the reservation query.

10. The computer-implemented method of claim 1, wherein:
generating from the publisher logs publisher data for each publisher comprises:
sampling the past impressions delivered on publisher sites at a rate of 1/M; and
including in each impression record an impression count equal to M;
assigning forecasted impressions that match the sharded reservation query to the one or more reservations comprises assigning to the one or more reservations for each matching forecasted impression a count value equal to the sum of the impression counts of the forecasted impressions assigned to the reservation; and
providing reservation results data specifying the number of forecasted impressions assigned to each of the one or more reservations to the mixer server comprises providing results data specifying, for each of the one or more reservations, the sum of the impression counts of the forecasted impressions assigned to each of the one or more reservations.

11. The computer-implemented method of claim 2, wherein each impression record is a row in a data store, and includes attribute data defining a plurality of attributes associated with each user identifier, the attribute data, user data corresponding to a user identifier data, and time data stored in respective columns, and the reservation query and sharded reservation query further include targeting data specifying targeting criteria for each of the reservations; and
further comprising, for each query server:
storing the content of each column in a respective data file; and
determining forecasted impressions for the publisher site from the impression records stored in the publisher data shard comprises accessing only the respective data files corresponding to columns that are relevant to the targeting data of the sharded reservation query.

12. The computer-implemented method of claim 1, wherein determining forecasted impressions for the publisher site from the impression records stored in the publisher data shard comprises:
seasonally shifting the impressions specified in the impression records of the publisher data shard to a future time period to generate the forecasted impressions.

13. The computer-implemented method of claim 12, wherein assigning forecasted impressions that match the sharded reservation query to the one or more reservations comprises:
for each forecasted impression:
determining a set of matching reservations from the sharded reservation query and a forecasted impression;
comparing a satisfaction value for each reservation in the set of matching reservations, the satisfaction value based on a ratio of forecasted impressions currently assigned to the reservation and the number of requested impressions specified by the sharded reservation query; and
assigning the forecasted impression to one of the reservations in the set of matching reservations based on the comparison of the satisfaction values.

14. The computer-implemented method of claim 13, wherein assigning forecasted impressions that match the sharded reservation query to the one or more reservations comprises randomly selecting with respect to the impression times a forecasted impression.

15. A system, comprising:
a mixer server that performs operations comprising:
receiving a reservation query for a reservation, the reservation query including, for each of the one or more reservations, data specifying a date range for the reservation during which content is to be displayed with a web resource, a number of requested impressions to deliver during for the reservation during the date range, and a publisher identifier identifying a publisher site hosting the web resource;
translating the reservation query into a plurality of sharded reservation queries, receiving a plurality of reservation results responsive to the sharded reservation queries, aggregating the reservation results and providing the aggregated reservation results as a response to the reservation query;
a plurality of query servers associated with a plurality of publisher data shards, wherein each publisher data shard stores a proper subset of impression records corresponding to the publisher site and a plurality of user identifiers, each impression record including user identifier data corresponding to a user identifier and time data specifying a time that an impression was delivered from the publisher site for the corresponding user identifier, and all impression records corresponding to the user identifiers are stored in the publisher data shard;
wherein each query server is associated with only one of the publisher data shards and performs operations comprising:
receiving a corresponding sharded reservation query from the mixer server;
determining forecasted impressions for the publisher site from the impression records stored in the publisher data shard, each forecasted impression specifying an impression time that the forecasted impression occurs;
assigning forecasted impressions that match the sharded reservation query to the one or more reservations and providing a reservation result specifying the number of forecasted impressions assigned to each of the one or more reservations to the mixer server.

16. The system of claim 15, further comprising a log server that performs operations comprising:
generating from the publisher logs publisher data for each publisher comprises hashing the corresponding user identifiers of the publishing logs and sorting the past impressions of the publisher logs by the hashed user identifiers; and
sharding the publisher data into a set of publisher data shards for the publisher comprises:
determining a total number q of records in the publisher data;
for each of the publisher data shards:
selecting an exclusive set of records in the publisher data, wherein the exclusive set of records has a cardinality of approximately q/n, n being equal to the number of publisher data shards, and wherein the exclusive set of records for the query server includes all records corresponding to the user identifiers in the exclusive set and is exclusive of records in other exclusive sets; and
storing as impression records in each publisher data shard the hash of a user identifier as the user identifier data, and time data specifying the time that the impression was delivered for the corresponding user identifier; and
providing the publisher data shards to corresponding query servers.

17. The system of claim 15, further comprising a log server that performs operations comprising:
accessing publisher logs defining past impressions delivered on publisher sites and times that each past impression was delivered for a corresponding user identifier;
generating from the publisher logs publisher data for each publisher, the publisher data for each publisher comprising impression records, each impression record representing an impression and including user identifier data corresponding to a user identifier and time data specifying the time that the impression was delivered for the corresponding user identifier; and
for each publisher:
sharding the publisher data into a set of publisher data shards for the publisher; and
providing each of the publisher data shards in the set of publisher data shards to its associated query server.

18. The system of claim 17, wherein:
generating from the publisher logs publisher data for each publisher comprises:
hashing the corresponding user identifiers of the publishing logs; and
sorting the past impressions of the publisher logs by the hashed user identifiers; and
sharding the publisher data into a set of publisher data shards for the publisher comprises:
determining a modulus of each hash of a corresponding user identifier, wherein each value is modulo n, and wherein n is equal to the number of query servers;
associating each publisher data shard and query server with a corresponding modulo n value;
storing as an impression record in each publisher data shard associated with a corresponding modulo n value the hash of a user identifier having a modulus n as the user identifier data, and time data specifying the time that the impression was delivered for the corresponding user identifier; and
providing each publisher data shard associated with a corresponding modulo n value to the corresponding query server associated with the modulo n value.

19. The system of claim 15, wherein:
the reservation query includes a frequency cap value for a reservation specifying maximum number of impressions for a user identifier during the date range; and
assigning forecasted impressions that match the sharded reservation query to the one or more reservations comprises assigning to the reservation no more than the maximum number of impressions corresponding to any user identifier.

20. The system of claim 19, wherein translating the reservation query into the plurality of sharded reservation queries comprises specifying, for each of the one or more reservations, a number of requested impressions to deliver during the date range for the reservation for each sharded query equal to the number of requested impressions for the reservation divided by the number of query servers.

21. The system of claim 15, wherein:
generating from the publisher logs publisher data for each publisher comprises:
sampling the past impressions delivered on publisher sites at a rate of 1/M; and
including in each impression record an impression count equal to M;
assigning forecasted impressions that match the sharded reservation query to the one or more reservations comprises assigning to the one or more reservations for each matching forecasted impression a count value equal to the sum of the impression counts of the forecasted impressions assigned to the reservation; and
providing a reservation result specifying the number of forecasted impressions assigned to the one or more reservation to the mixer server comprises providing a reservation result specifying, for each of the one or more reservations, the sum of the impression counts of the forecasted impressions assigned to the reservation.

22. The system of claim 17, wherein each impression record is a row in a data store, and includes attribute data define a plurality of attributes associated with each user identifier, the attribute data, user data corresponding to a user identifier data, and time data stored in respective columns, and the reservation query and sharded reservation queries further include targeting data specifying targeting criteria for each of the one or more reservations; and
further comprising, for each query server:
storing the content of each column in a respective data file; and
determining forecasted impressions for the publisher site from the impression records stored in the publisher data shard comprises accessing only the respective data files corresponding to columns that are relevant to the targeting data of the sharded reservation query.

23. The system of claim 15, wherein:
determining forecasted impressions for the publisher site from the impression records stored in the publisher data shard comprises:
seasonally shifting the impressions specified in the impression records of the publisher data shard to a future time period to generate the forecasted impressions; and
assigning forecasted impressions that match the sharded reservation query to the one or more reservations comprises:
for each forecasted impression:
determining a set of matching reservations from the sharded reservation query and the forecasted impression;
comparing a satisfaction value for each reservation in the set of matching reservations, the satisfaction value based on a ratio of forecasted impressions currently assigned to the reservation and the number of requested impressions specified by the sharded reservation query; and
assigning the forecasted impression to one of the reservations in the set of matching reservations based on the comparison of the satisfaction values.

24. The system of claim 23, wherein assigning forecasted impressions that match the sharded reservation query to one or more of the reservations comprises randomly selecting with respect to the impression times a forecasted impression.

25. Software stored in a computer readable medium storage and comprising instructions executable by a data processing apparatus and upon such execution causes the data processing apparatus to perform operations comprising:
receiving a reservation query for one or more reservations, the reservation query including data specifying, for each of the one or more reservations, a date range for the reservation during which content is to be displayed with a web resource, a number of requested impressions to deliver during the date range for the reservation, and a publisher identifier identifying the a publisher site hosting the web resource;
translating the reservation query into a plurality of sharded reservation queries and providing each sharded reservation query corresponding to a publisher data shard, wherein each publisher data shard stores a proper subset of impression records corresponding to the publisher site and a plurality of user identifiers, each impression record including user identifier data corresponding to a user identifier and time data specifying a time that an impression was delivered from the publisher site for the corresponding user identifier, all impression records corresponding to the user identifiers are stored in the publisher data shard;
separately determining, for each publisher data shard, forecasted impressions for the publisher site from the impression records stored in the publisher data shard, each forecasted impression specifying an impression time that the forecasted impression occurs;
separately assigning, for each publisher data shard, forecasted impressions that match the sharded reservation query to the one or more reservations; and
aggregating the reservation results data received for each publisher data shard and provided the aggregated reservation results data as a response to the reservation query.
